(19) United States
(12) Patent Application Publication
(10) Pub. No.: US 2010/0210288 A1
(43) Pub. Date: Aug. 19, 2010

(54) OPTIMIZED PAGING METHOD FOR HOME (E)NODEB SYSTEM

(76) Inventors: Hyun-Sook KIM, Gyeonggi-Do (KR); Lae-Young Kim, Gyeonggi-Do (KR); Tae-Hyeon Kim, Gyeonggi-Do (KR)

Correspondence Address: BIRCH STEWART KOLASCH & BIRCH, PO BOX 747, FALLS CHURCH, VA, 22040-0747, US

(21) Appl. No.: 12/625,608

(22) Filed: Nov. 25, 2009

Related U.S. Application Data
(60) Provisional application No. 61/152,264, filed on Feb. 13, 2009.

(30) Foreign Application Priority Data
Aug. 19, 2009 (KR) 10-2009-0075885

(51) Int. Cl. H04W 68/02

(52) U.S. Cl. 455/458

(57) ABSTRACT

An optimized paging method for a Home (e)NodeB system comprises: receiving, by a network entity, a notification message indicating whether downlink data for a terminal exists or not; determining, by the network entity, one or more Home (e)NodeBs to which a paging message is to be transmitted among one or more base stations included in a base station list for the terminal, based on an access mode of the Home (e)NodeB, and based on whether the terminal is a member of a Closed Subscriber Group (CSG) supported by the Home (e)NodeB; to transmitting, by the network, a paging message to the determined one or more Home (e)NodeBs or (e)NodeBs included in the base station list; and receiving, by the network, a paging response message from a specific (e)NodeB or Home (e)NodeB among the one or more (e)NodeBs or Home (e)NodeBs to which the paging message has been transmitted.

### CROSS-REFERENCE TO A RELATED APPLICATION

Pursuant to 35 U.S.C. §119(a), this application claims the benefit of U.S. Provisional Application No. 61/152,264, filed on Feb. 13, 2009 and the benefit of earlier filing date and right of priority to Korean Application No. 10-2009-0075885, filed on Aug. 17, 2009, the content of which is incorporated by reference herein in its entirety.

### BACKGROUND OF THE INVENTION

1. Field of the Invention

The present invention relates to a mobile communication system, and particularly, to a Home (e)NodeB system in a mobile communication system.

2. Background of the Invention

In the field of 3GPP that regulates technical standards of the third generation mobile communication system, since the end of 2004, has started researches for Long Term Evolution/System Architecture Evolution (LTE/SAE) techniques to optimize and enhance functions of 3GPP techniques in correspondence to a plurality of forums and new techniques relevant to the 4^{th} generation mobile communication.

The SAE based on the 3GPP SA WG2 relates to a network technique for determining a network structure and supporting mobility of a heterogeneous radio network system with cooperating with an LTE operation of the 3GPP TSG RAN. The SAE, one of the most important standardization issues of the 3GPP, is implemented to develop a 3GPP system into a system that supports various wireless access techniques based on IP. More concretely, the SAE has been implemented for an optimized packet-based system capable of minimizing transmission delay with an enhanced data transmission capability.

A conceptual reference model of the SAE, defined by 3GPP SA WG2 includes a non-roaming case, and a roaming case having various scenarios. Details of the conceptual reference model can be referred from TS 23.401 and TS 23.402 which are 3GPP standard documents. This may be schematically reconfigured in FIG. 1.

FIG. 1 is a structural view of an evolved mobile communication network.

One of the most representative characteristics of the network of FIG. 1 is that a structure is based on a two-layer model (2 Tier Model), an evolved NodeB (so-called eNodeB) of an Evolved UTRAN and a Gateway of a Core Network. The eNodeB has similar functions to them of both a RNC and a NodeB of the conventional UMTS system. And, the Gateway has a similar function to it of the conventional SGSN/GGSN.

Another important characteristic of the network is that a Control Plane and a User Plane between an Access Network and a Core Network are interchanged to each other through different interfaces. In the conventional UMTS system, one interface (Iu) exists between an RNC and an SGSN. However, since a Mobility Management Entity (MME) which processes a control signal is separated from a Gateway (GW), two interfaces (i.e, S1-MME and S1-U) were respectively used.

FIG. 2 shows an (e)NodeB and a Home (e)NodeB.

In the 3^{rd} or 4^{th} generation mobile communication system, efforts to increase a cell capacity have been ongoing in order to support high-capacity service such as multimedia contents and streaming, and a bi-directional service.

As various techniques for transmitting a large amount of data in addition to multimedia relating techniques, are required many methods for increasing wireless capacity have been researched. One of the methods include a method for allocating frequency resources as much as possible. However, there have been limitations in allocating limited frequency resources to a plurality of users as much as possible.

In order to increase a cell capacity, there are efforts to use a high frequency bandwidth, and to reduce a cell radius. When cells having a small radius, such as pico cells are used, a frequency bandwidth of the cell can increase highly than that in the conventional cellular system thus to transmit more information. However, in this case, more base stations have to be installed in the same area, which results in high costs.

In order to increase a cell capacity by using a small cell, a femto-base station such as a Home (e)NodeB has been proposed.

Referring to FIG. 2, an (e)NodeB 20 may correspond to a macro-base station, whereas a Home (e)NodeB 30 may correspond to a femto-base station. In the specification, the terms will be explained based on the 3GPP. And, the (e)NodeB 20 will be used so as to indicate ‘NodeB’ or ‘eNodeB’, and the Home (e)NodeB 30 will be used so as to indicate ‘Home NodeB’ or ‘Home eNodeB’.

FIG. 3 is an exemplary view showing a structure of a network including the Home (e)NodeB.

As shown in FIG. 3A, a Core Network 50 includes a Mobility Management Entity (MME) 51, a Serving Gateway (S-GW) 52, a Serving GPRS Support Node (SGSN) 56, a Packet Data Network Gateway or a PDN Gateway (P-GW) 53. And, the core network 50 may further include a Policy Charging Resource Function (PCRF) 54 and a Home Subscriber Server (HSS) 55.

FIG. 3A shows a Home NodeB 31 of UTRAN (UMTS Terrestrial Radio Access Network, and a Home eNodeB 32 of E-UTRAN (Evolved-UTRAN). The Home NodeB 31 of UTRAN is connected to the SGSN 56 through a Gateway 35. The Home eNodeB 32 of E-UTRAN is connected to the MME 51 and the S-GW 52. Here, a control signal is transmitted to the MME 51, and a user data signal is transmitted to the S-GW 52. The Gateway 35 may exist between the Home eNodeB 32 by E-UTRAN and the MME 51.

FIG. 3B shows an interface of the Home eNodeB 32 of E-UTRAN. The Home eNodeB 32 and the Gateway 35 are referred to as a ‘Sub-System’. The Home eNodeB 32 is connected to the UE 10 through an LTE-Uu interface. The Home eNodeB 32 is connected to the MME 51 through an S1-MME interface. And, the Home eNodeB 32 is connected to the S-GW 52 through an S1-U interface. Here, the S1-MME interface and the S1-U interface may pass through the Gateway 35. The MME 51 and the S-GW 52 are connected to each other through an S11 interface, and the MME 51 and the HSS 55 are connected to each other through an S6a interface.

FIG. 4 is an exemplary view showing an interface between the Home eNodeB 32 and the MME 51 of FIG. 3 as a protocol stack.

As shown in FIG. 4, each of the Home eNodeB 32 and the MME 51 includes a first layer (physical layer), a second layer (Medium access Control (MAC) layer), a third layer (Internet Protocol (IP) layer), Signaling Control Transmission Protocol (SCTP), and S1 Application Protocol (S1-AP).

The S1-AP is an application protocol between the Home eNodeB 32 and the MME 51. The SCTP ensures transmission of a signaling message between the Home eNodeB 32 and the MME 51.

FIG. 5 is a flowchart showing a paging message transmitting process in accordance with the related art;

Referring to FIG. 5, once downlink data to be transmitted to the UE 10 reaches the MME 51, the MME 51 determines a macro-base station (e.g., (e)NodeB 20a) to which a paging signal is to be transmitted, among a plurality of macro base stations (e.g., (e)NodeBs 20a and 20b), based on a base station list having information about macro base stations for the terminal.

Next, the MME 51 transmits a paging signal to the determined macro-base station (e.g., (e)NodeB 20a). Then, the (e)NodeB 20a broadcasts the paging signal in pursuit of the UE 10.

Once the UE 10 transmits a Paging Response message with respect to the paging signal to the MME 51 through the (e)NodeB 20a, the MME 51 transmits the downlink data to the (e)NodeB 20a.

### SUMMARY OF THE INVENTION

Therefore, an object of the present invention is to provide an optimized paging method for a Home (e)NodeB system, capable of determining a base station to which a paging signal is to be transmitted, among a plurality of base stations by a mobility management entity (MME) in a Home (e)NodeB system where not only a general base station (i.e., (e)NodeB) but also a Home (e)NodeB exist, and capable of transmitting the paging signal to the determined base station.

Here, whether to transmit the paging signal or not may be determined according to a Home (e)NodeB configuration method (access mode).

The object of the present invention is to efficiently determine a femto base station such as Home (e)Node B to which the paging signal is to be transmitted, in an optimized manner.

To achieve these and other advantages and in accordance with the purpose of the present invention, as embodied and broadly described herein, there is provided an optimized paging method for a Home (e)NodeB system, the method comprising: receiving, by a network entity, a notification message indicating whether downlink data for a terminal exists or not; determining, by the network entity, one or more Home (e)NodeBs to which a paging message is to be transmitted among one or more base stations included in a base station list for the terminal, based on an access mode of the Home (e)NodeB, and based on whether the terminal is a member of a Closed Subscriber Group (CSG) supported by the Home (e)NodeB; transmitting, by a network entity, a paging message to the determined one or more Home (e)NodeBs or one or more (e)NodeBs included in the base station list; and receiving, by a network entity, a paging response message from a specific (e)NodeB or Home (e)NodeB among the one or more (e)NodeBs or Home (e)NodeBs to which the paging message has been transmitted.

The base station list may be a Tracking Area Identity (TAI) list. The TAI list may comprise an ID(s) of one or more (e)NodeBs for the terminal, and an ID(s) of one or more Home (e)Node Bs for the terminal.

In the determining step, at least one of a Closed Subscriber Group (CSG) ID, a network operator policy, and an operator policy of the Home (e)NodeB may be further considered.

After receiving the paging response message, the method may further comprise transmitting an Initial Context Setup Request message to the specific (e)NodeB or Home (e)NodeB such that a radio bearer is set between the specific (e)NodeB or Home (e)NodeB and the terminal.

The method may further comprise transmitting an Update Bearer Request message to a Serving-Gateway (S-GW) once the paging response message has been received; and receiving an Update Bearer Response message from the S-GW.

After receiving the Update Bearer Response message, the downlink data may be transmitted to the terminal through the specific (e)NodeB or Home (e)NodeB.

The network entity may be a Mobility Management Entity (MME), or other network entity which performs a paging function.

To achieve these and other advantages and in accordance with the purpose of the present invention, as embodied and broadly described herein, there is also provided a network server configured to perform a paging function for a Home (e)NodeB system, the server comprising: a transceiver configured to receive a notification message indicating whether downlink data for a terminal exists or not; and a controller configured to determine one or more Home (e)NodeBs to which a paging message is to be transmitted among one or more base stations included in a base station list for the terminal, based on an access mode of the Home (e)NodeB, and based on whether the terminal is a member of a Closed Subscriber Group (CSG) supported by the Home (e)NodeB.

The controller may control to transmit the paging message, through the transceiver, the determined one or more Home (e)NodeBs or one or more (e)NodeBs included in the base station list. And, the transceiver may receive a paging response message from a specific (e)NodeB or Home (e)NodeB among the one or more (e)NodeBs or Home (e)NodeBs to which the paging message has been transmitted.

The optimized paging method according to the present invention may have the following advantages.

Firstly, waste of network resources may be prevented and the network efficiency may be enhanced. Here, the waste of network resources was conventionally caused due to paging failure that may frequently result from unnecessary transmission of a paging message in the case that an access mode of the Home (e)NodeB has not been considered.

Furthermore, paging delay may be reduced thereby to provide high-quality service to a user.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a structural view of an evolved mobile communication network;

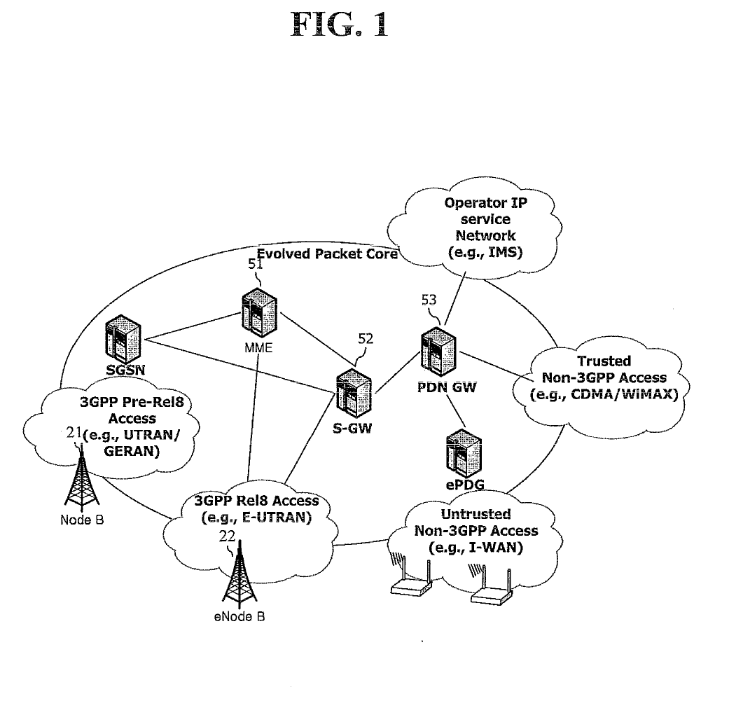

FIG. 2 shows an (e)NodeB and a Home (e)NodeB;

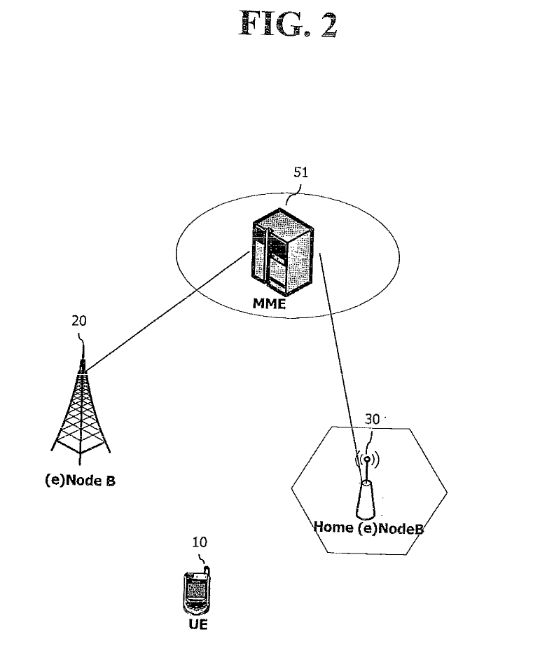

FIG. 3 is an exemplary view showing a structure of a network including the Home (e)NodeB;

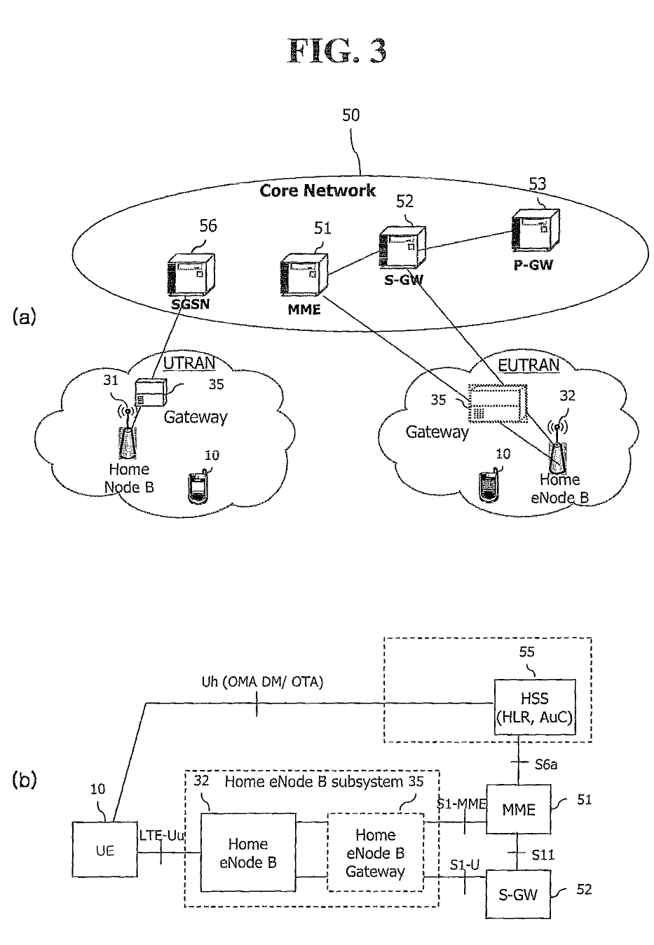

FIG. 4 is an exemplary view showing an interface between a Home eNodeB 32 and an MME 51 of FIG. 3 as a protocol stack;

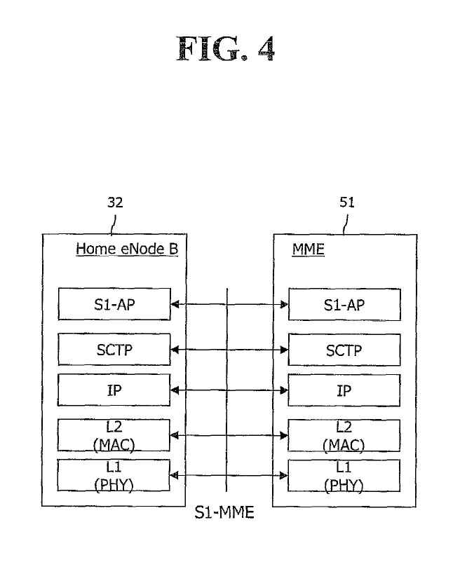

FIG. 5 is a flowchart showing a paging transmitting process in accordance with the related art;

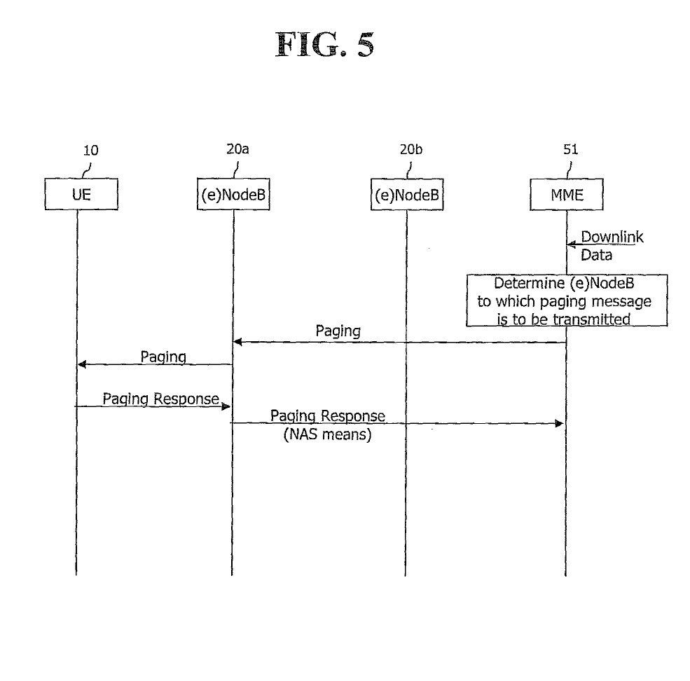

FIG. 6 is an exemplary view showing an operation mode of a Home (e)NodeB 300 according to the present invention;

FIG. 7 is an exemplary view showing a paging method according to the present invention;

FIG. 8 is a table showing information to be obtained and a method for obtaining information;

FIG. 9 is a flowchart showing a method for obtaining configuration information and relevant information of the Home (e)NodeB by an MME 510 according to the present invention;

FIG. 10 is an exemplary view of a bearer (tunnel) established according to FIG. 9;

FIG. 11 shows paging signal transmitting processes when the present invention has been applied and when the present invention has not been applied; and

FIG. 12 is a block diagram of the MME 510 according to the present invention.

### DETAILED DESCRIPTION OF THE INVENTION

Description will now be given in detail of the present invention, with reference to the accompanying drawings.

The present invention is applied to a Home (e)NodeB system. Here, the Home (e)NodeB indicates a Home NodeB and a Home eNodeB. However, the present invention is not limited to this, but may be applied to all communication systems and methods to which the techniques of the present invention are applicable.

Unless differently defined, all the terms used herein with including technical or scientific terms have the same meaning as terms generally understood by those skilled in the art relating to the field of the present invention. Terms defined in a general dictionary should be understood so as to have the same meanings as contextual meanings of the related art. Unless definitely defined in the present invention, the terms are not interpreted as ideal or excessively formal meanings. Furthermore, when the technical terms used in the present invention are unsuitable technical terms that do not precisely express the techniques of the present invention, the unsuitable technical terms should be replaced by suitable technical terms that can be understood by those skilled in the art. The general terms used in the present invention should be interpreted based on the previous or next contexts, but should not be interpreted as an excessively narrowed meaning.

A singular expression includes a plural concept unless there is a contextually distinctive difference therebetween. In the present invention, a term of “include” or “have” should not be interpreted as if it absolutely includes a plurality of components or steps of the specification. Rather, the term of “include” or “have” may not include some components or some steps, or may further include additional components.

Though terms of ‘first’, ‘second’, etc. are used to explain various components, the components are not limited to the terms. The terms are used only to distinguish one component from another component. For example, a first component may be referred to as a second component, or similarly, the second component may be referred to as the first component within the scope of the present invention.

When it is mentioned that one component is “connected” or “accessed” to another component, it may be understood that the one component is directly connected or accessed to the another component or that still other component is interposed between the two components. In the meantime, when it is mentioned that one component is “directly connected” or “directly accessed” to another component, it may be understood that no component is interposed therebetween.

Hereinafter, preferred embodiments of the present invention will be explained in more detail with reference to the attached drawings. The same or similar components of one embodiment as or to those of another embodiment will be provided with the same or similar reference numerals, and their detailed explanations will be omitted. And, if it is judged that detailed descriptions of the related art are not within the range of the present invention, the detailed descriptions will be omitted.

For clarity, the present invention will be explained based on 3GPP EUTRAN/EPC. However, the present invention is not limited thereto. Especially, a specific network entity will be explained based on EUTRAN/EPC, and refers to a mobility management entity (MME). However, the specific network entity may be widely used to a second network entity which determines a paging, e.g., a Home (e)NodeB gateway, etc. In the detailed description of the present invention, a Home (e)NodeB gateway (a node between a Home (e)NodeB and a core network) will be explained based on an omitted network structure. However, the Home (e)NodeB gateway may be also applied to the existing network structure in a similar manner.

Hereinafter, the term of a ‘mobile terminal’ will be used. The mobile terminal may be also referred to as a user equipment (UE), a mobile equipment (ME), and a mobile station (MS). The UE may be a mobile device having a communication function, such as a portable phone, a PDA, a smart phone, and a notebook. Also, the UE may be an immobile device such as a PC and a vehicle mounted device.

### DEFINITION OF TERMS

Hereinafter, the terms used in the present invention will be briefly defined for understanding.

UMTS: An abbreviation of a Universal Mobile Telecommunication System, which signifies the 3^{rd} generation mobile communication network.

EPS: An abbreviation of an Evolved Packet System, which signifies an efficient network structure that supports an evolved RAN by evolving a core network of the conventional 3GPP system architecture, and that simplifies a network entity so as to enhance the efficiency of a packet network.

NodeB: A base station of a UMTS network, which has a cell coverage size corresponding to a macro cell.

eNodeB: A base station of an EPS network, which has a cell coverage size corresponding to a macro cell.

(e)NodeB: A term indicating a NodeB and an eNodeB.

Home NodeB: A base station of a UMTS network, which has a cell coverage size corresponding to a femto cell. This connects a 3GPP-based UE to a mobile operator's network through a UTRAN wireless air interface.

Home eNodeB: A base station of an EPS network, which has a cell coverage size corresponding to a femto cell. This connects a 3GPP-based UE to a mobile operator's network through an E-UTRAN wireless air interface.

Home (e)NodeB: A term indicating a Home NodeB and a Home eNodeB.

Home (e)NodeB gateway: A gateway performing an interfacing with a core network by being connected to one or more Home (e)NodeBs.

Home (e)NodeB sub-system: A sub-system that manages a wireless network by combing a Home (e)NodeB and a Home (e)NodeB gateway as one set in a network structure that the Home (e)NodeB gateway is implemented together with the Home (e)NodeB. The Home (e)NodeB sub-system and the Home (e)NodeB manage a wireless network, and are interworked with a core network. Therefore, the Home (e)NodeB sub-system and the Home (e)NodeB may be considered as one set. Accordingly, the terms of the Home (e)NodeB and the Home (e)NodeB sub-system will be used together.

Closed Subscriber Group (CSG): A specific membership group based on subscriber's information so as to permit access of only allowed UEs to a cell of the Home (e)NodeB.

Open Access Mode: A term indicating that the Home (e)NodeB operates in the same manner as a normal cell (non-CSG cell) having no concept of a CSG. That is, a term indicating that the Home (e)NodeB operates in the same manner as a general (e)NodeB.

Closed Access Mode: A term indicating that the Home (e)NodeB operates as a CSG cell. A term indicating that the Home (e)NodeB operates to permit access of only allowed UEs to the corresponding cell. That is, a term indicating that only UEs having priorities of specific CSG IDs supported by the Home (e)NodeB are accessible to the Home (e)NodeB.

Hybrid Access Mode: A term indicating that the Home (e)NodeB operates as a CSG cell, but allows access of even a non-CSG subscriber. The Home (e)NodeB can permit accesses from UEs having specific IDs thereby to provide a service to the UEs. Furthermore, the Home (e)NodeB operated in Hybrid Access Mode permits accesses from UEs having no CSG ID.

CSG Cell: A cell of a Public Land Mobile Network (PLMN), to which only members of the CSG group can access. For this, the CSG cell broadcasts a CSG ID. CSG cells which share the same ID can be identified or managed as one group for mobility management and charging.

CSG ID: An identifier broadcast by the CSG cell, which is used to facilitate access by an authorized member of the CSG. The CSG ID may be unique within only one PLMN.

Tracking Area: A unit of an area to track the location of a UE 100 operated in an idle mode. That is, a unit of an area to register the location of the UE 100. An ID of a specific area is referred to as a Tracking Area Identity (TAI). In an EPS, the UE can simultaneously register its location to a plurality of TAIs for efficient mobility management when the UE is in an idle mode. In this case, a TAI list is managed.

TAI LIST: Location information registered to an HSS or an HLR through a mobility management entity (MME) as the location of the UE is moved, i.e., a set of an (e)NodeB or a Home (e)NodeB.

PCC (Policy and Charging Control): An operation for an operator's policy and charging.

PCRF (Policy and Charging Rule Function): A functional network element having a policy of an operator for performing the PCC, and a charging rule. The PCRF provides an operator policy and a charging rule to another node.

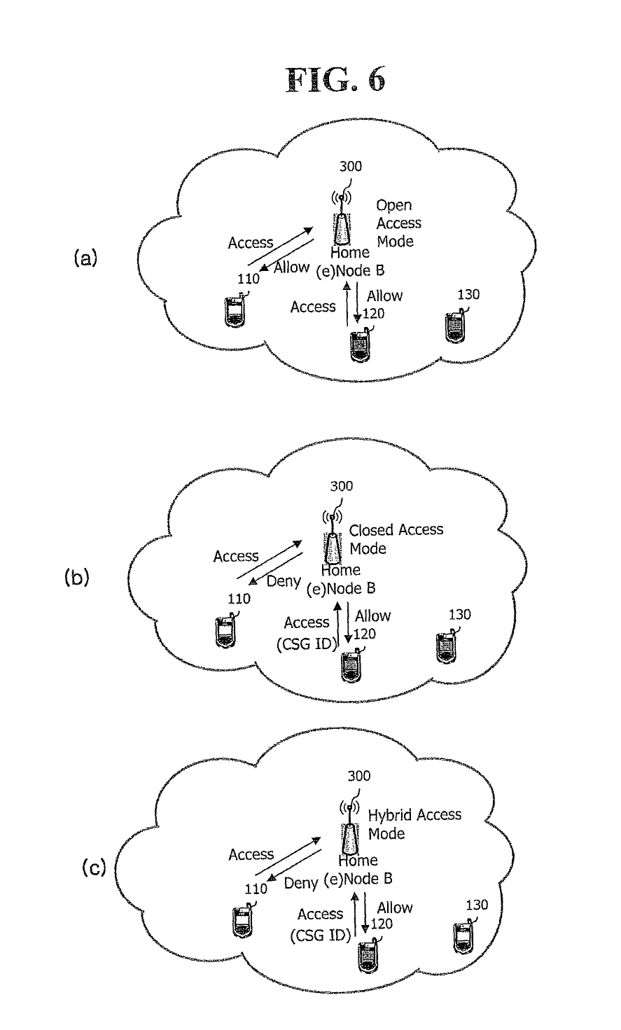

FIG. 6 is an exemplary view showing an operation mode of the Home (e)NodeB according to the present invention.

The aforementioned femto base station, e.g., the Home (e)NodeB 300 may operate in the Open Access Mode as illustrated in FIG. 6A, the Closed Access Mode as illustrated in FIG. 6B, and the Hybrid Access Mode as illustrated in FIG. 6C.

FIG. 6A shows an example of the open access mode. As aforementioned, the open access mode indicates that all UEs are accessible to a cell of the Home (e)NodeB 300. Accordingly, a plurality of UEs 110, 120 and 130 are allowed to access to the cell of the Home (e)NodeB 300.

FIG. 6B shows an example of the closed access mode. The closed access mode indicates that the Home (e)NodeB 300 operates as a CSG cell. That is, only allowed UEs are accessible to the Home (e)NodeB 300. The Home (e)NodeB 300 has a CSG ID. Each user receives an allowance to each CSG.

FIG. 6C shows an example of the hybrid access mode. The hybrid access mode indicates that the Home (e)NodeB 300 operates as a CSG cell that provides service to CSG members, but access of a UE, a non-CSG member, to the Home (e)NodeB 300 can also be allowed. For instance, even if the first UE 110 is not a CSG member (in other words, the first UE 110 doesn't have a proper CSG ID), the first UE 110 can access to the Home (e)NodeB 300.

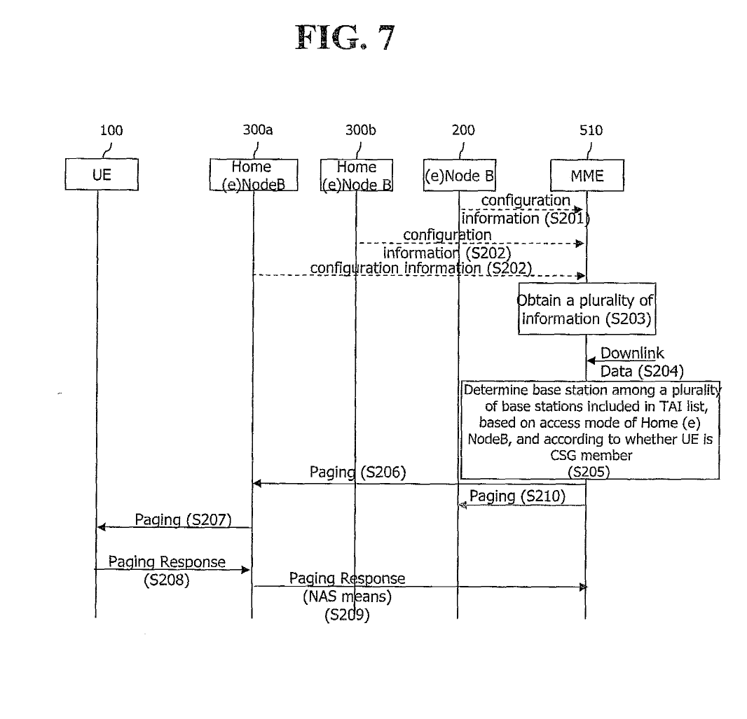

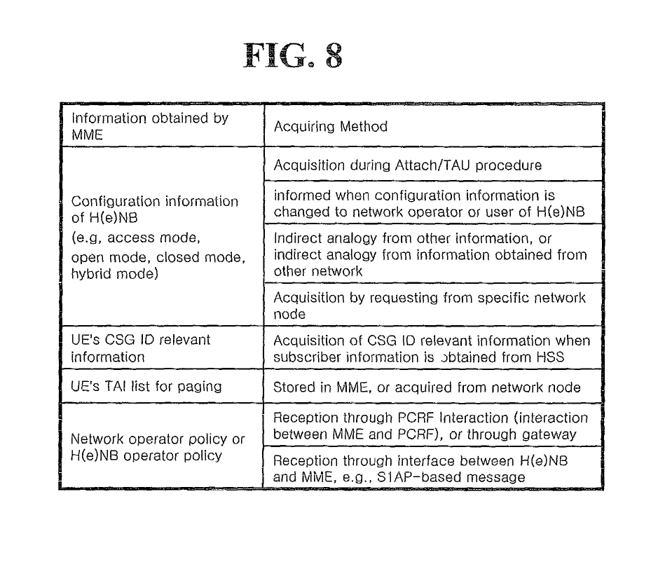

FIG. 7 is an exemplary view showing a paging method according to the present invention, and FIG. 8 is a table showing information to be obtained and a method for obtaining information.

Referring to FIG. 7, an MME 510 determines one or more Home (e)NodeBs (base station) to which a paging message is to be transmitted among one or more base stations included in a base station list for the UE 100 (e.g., TAI list), based on an access mode of a Home (e)NodeB, and based on whether the UE 100 is a member of the Home (e)NodeB.

The paging method according to the present invention will be explained in more detail.

Firstly, the MME 510 receives configuration information from an (e)NodeB 200 (S201). Also, the MME 510 may receive, from the Home (e)NodeBs 300a and 300b, access mode information (e.g., open access mode, closed access mode, and hybrid access mode) as well as configuration information (S202). It is noted that the configuration information according to the present invention has meanings with including the access mode information. Here, the MME 510 may receive the configuration information (including the access mode information) from other network entity rather than the Home (e)NodeBs 300a and 300b, e.g., an additional network entity where the access mode information of the Home (e)NodeB has been stored.

The MME 510 obtains a plurality of additional information (S203). The plurality of additional information includes TAI(s), etc.

Then, the MME 510 determines the Home (e)NodeB 300a to which a paging message is to be transmitted among one or more base stations (for example, as Home (e)NodeBs and (e)NodeBs) included in a base station list for the UE 100 (e.g., TAI list) In the determination, the MME 510 can consider access modes of the Home (e)NodeBs 300a and 300b Also, in the determination, the MME 510 can further consider whether the UE 100 is a member of a Closed Subscriber Group (CSG) supported by the Home (e)NodeBs 300a and 300b (S205). For example, in order to select a proper Home (e)NodeB, the MME 510 checks the base station list (TAI list), determines in which mode each of Home (e)NodeBs included in the base station list is operating among an open access mode, a closed access mode and a hybrid access mode (or determines whether there is a Home (e)NodeB operated in a hybrid access mode or a closed access mode), and then determines whether the terminal has a proper CSG membership for accessing to a Home (e)NodeB operated in closed access mode or hybrid access mode.

Then, the MME 510 transmits a paging message to the determined Home (e)NodeB 300a (S206). Here, the paging message may be also transmitted to the (e)NodeB 200 included in the TAI list (S210).

Referring to FIG. 8, the plurality of information obtained by the MME 510 includes at least one of configuration information (including access mode information) of the Home (e)NodeBs 300a and 300b, information relating to the UE's CSG ID, TAI(s), and a network operator policy or a policy of an owner of the Home (e)NodeBs 300a and 300b.

The configuration information of the Home (e)NodeBs 300a and 300b includes access mode information indicating that the Home (e)NodeBs 300a and 300b operate in which access mode among the open access mode, the closed access mode, and the hybrid access mode. This configuration information (including the access mode information) may be obtained from the Home (e)NodeBs 300a and 300b while the UE 100 tries to attach to the Home (e)NodeBs 300a and 300b, or during a TAU procedure. Alternatively, the configuration information (including the access mode information) may be obtained by the MME 510 when being changed by a network operator or an owner of the Home (e)NodeBs 300a and 300b. In another alternative manner, the configuration information (including the access mode information) may be obtained from other information acquired by the MME 510 in an analogical manner, or may be obtained from information acquired by other network entity in an indirect analogical manner. In another alternative manner, the configuration information (including the access mode information) may be obtained according to a request of the MME 510 from other second network entity, e.g., an additional second network entity where the configuration information (including the access mode information) of the Home (e)NodeB has been stored.

The information relating to the UE's CSG ID may be obtained when the MME 510 obtains a specific UE's subscriber information from an HSS 550.

The TAI(s) may be directly stored in the MME 510, or may be obtained from other second network, e.g., the HSS, etc.

The network operator policy may be received through PCRF interaction between the MME 510 and PCRF, or may be obtained through a gateway. The policy of an owner of the Home (e)NodeB may be obtained through an S1 AP interface with the Home (e)NodeBs 300a and 300b.

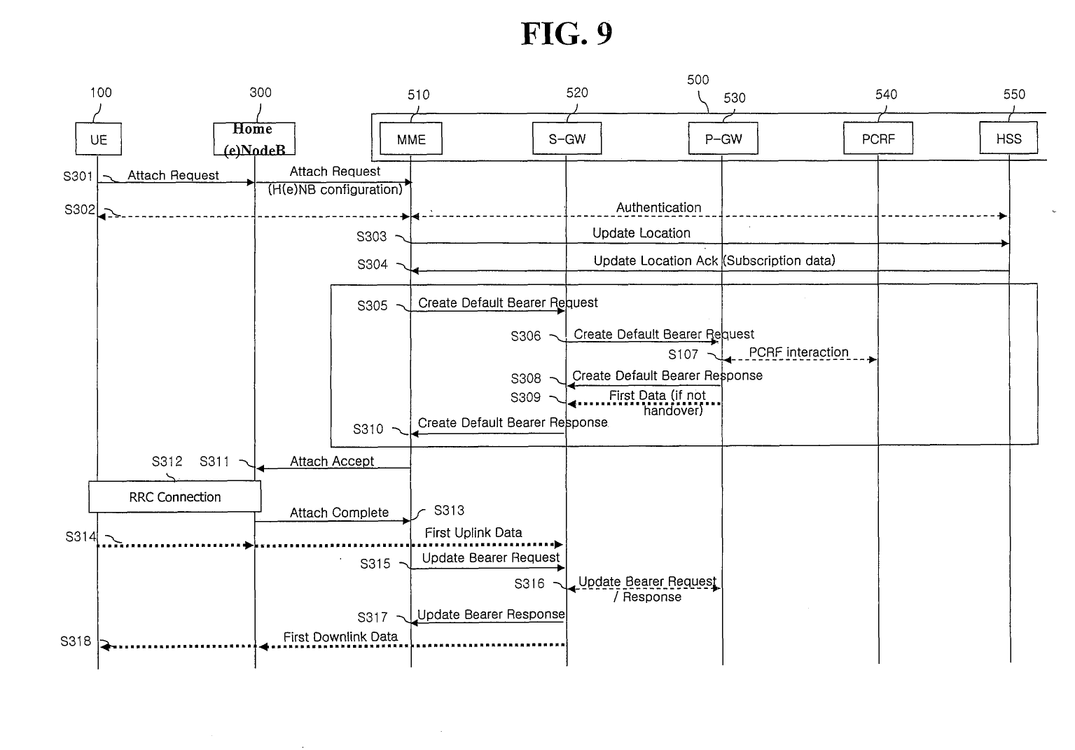

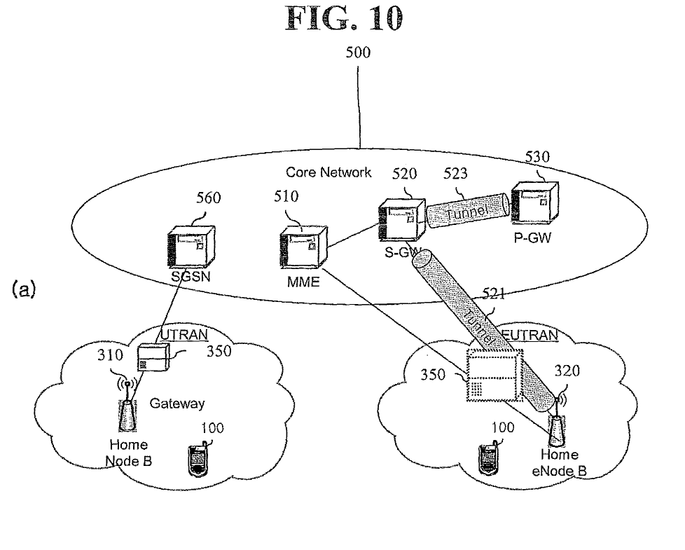

FIG. 9 is a flowchart showing a method for obtaining configuration information and relevant information of the Home (e)NodeB by an MME 510 according to the present invention, and FIG. 10 is an exemplary view of a bearer (tunnel) established according to FIG. 9.

Firstly, the UE 100 transmits an Attach Request message to the Home (e)NodeB 300 (S301). Then, the Home (e)NodeB 300 receives the Attach Request message, and transmits the received Attach Request message to the MME 510 with including its configuration information.

Next, the UE 100 performs an authentication procedure to the HSS 550 (S302). The MME 510 transmits a request message such as a Update Location message for request update of the location of the UE 100 to the HSS 550 if necessary (S303). Then, the MME 510 receives a response message such as an Update Location ACK message (S304). Here, the response message includes subscriber information of the UE 100, e.g., whether the UE 100 is a member of a CSG (in this case, expire information, etc. may be included), CSG ID information, etc.

The MME 510 sets (establishes) a tunnel with an S-GW 520 and a P-GW 530. More concretely, the MME 510 transmits a bearer creation request message, e.g., a Create Default Bearer Request message, to the S-GW 520 (S305). Then, the S-GW 520 transmits the received bearer creation request message (e.g., the Create Default Bearer Request message) to the P-GW 530 (S306). The P-GW 530 selectively performs a PCRF interaction with a PCRF 540 (S307). Here, the P-GW 530 may obtain a network operator policy through the PCRF Interaction. The P-GW 530 transmits a bearer creation response message, e.g., a Create Default Bearer Response message, to the S-GW 520 (S308). Accordingly, as shown in FIG. 10, a tunnel (e.g., a default bearer 523) is created between the S-GW 520 and the P-GW 530, and a Tunnel Endpoint ID (TEID) for data transfer is exchanged therebetween. The TEID is a parameter serving as an address for transmission and reception of data. Here, the bearer creation response message (e.g., Create Default Bearer Response message) may include the aforementioned network operator policy. When the P-GW 530 has download date to be transmitted to the UE 100, the P-GW 530 may transmit the download data to the S-GW 520 through the created bearer (S309). The S-GW 520 transmits the bearer creation response message (e.g., Create Default Bearer Response message) to the MME 510 (S310). The Create Default Bearer Response message may include a TEID of the S-GW 520.

The MME 510 transmits an attach allowance message, e.g., an Attach Accept message, to the Home (e)NodeB 300 (S311). The attach allowance message (e.g., Attach Accept message) includes the TEID, and triggers a wireless bearer setup between the Home (e)NodeB 300 and the UE 100.

The Home (e)NodeB 300 and the UE 100 executes an RRC connection procedure (S312). The Home (e)NodeB 300 transmits a message informing that the attach has been completed, e.g., Attach Complete message to the MME 510 (S313). Accordingly, as shown in FIG. 10, a tunnel 521 is set between the UE 100 and the S-GW 520. The UE 100 can transmit its uplink data to the S-GW 520 through the Home (e)NodeB 300 (S314). The Attach Completion message includes a TEID of the Home (e)NodeB 300.

For update of the established default bearer 523 of FIG. 10, the MME 510 transmits a request message for requesting an update of the bearer, e.g., a bearer update request message an Update Bearer Request message, to the S-GW 520 (S315). The request message (e.g., Update Bearer Request message) includes the TEID of the Home (e)NodeB 300. The S-GW 520 deliveries the request message (e.g., the Update Bearer Request message) to the P-GW 530, and the P-GW 530 transmits a response message, e.g., an Update Bearer Response message to the S-GW 520 (S316). Then, the S-GW 520 deliveries the response message to the MME 520 (S317). Once the established default bearer 523 is updated through these procedures, the S-GW 520 transmits downlink data to the UE 100 through the Home (e)NodeB 300.

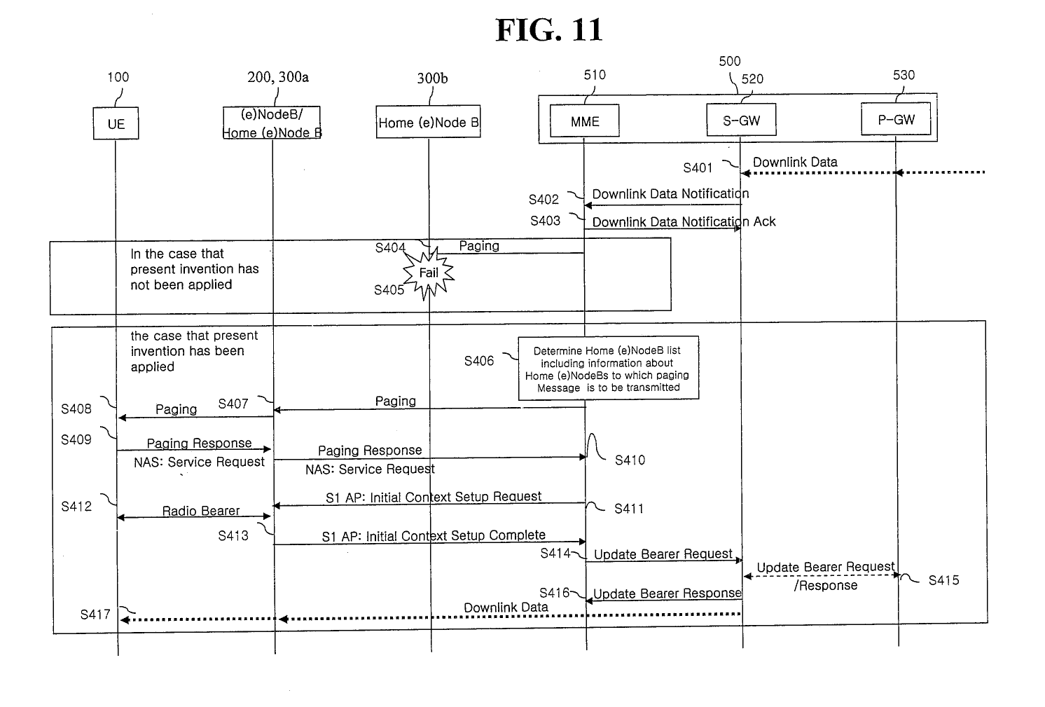

FIG. 11 shows paging signal transmitting processes when the present invention has been applied and when the present invention has not been applied.

In the case that the P-GW 530 has download data to be transmitted to the UE 100 (e.g., data from the UE 100 or server), the P-GW 530 can transmit the download data to the S-GW 520 through the bearer created in S309 in FIG. 9 (S401).

The S-GW 520 notifies the existence of downlink data to the MME 510 corresponding to a control plane node (S402). That is, the S-GW 520 transmits a downlink data notification to the MME 510.

In this case, if the present invention is not applied, the MME 510 determines, based on TAI (s), the Home (e)NodeB 300b to which a paging message is to be transmitted, and transmits a paging message to the Home (e)NodeB 300b (S404). However, in the case that the UE 100 is not a member of the CSG even if the Home (e)NodeB 300b operates in a closed access mode, the UE 100 may not be connected to the Home (e)NodeB 300b. Nonetheless, in the case that the present invention is not applied, the MME 510 transmits a paging message to the Home (e)NodeB 300b, and the Home (e)NodeB 300b broadcasts the paging message to cells managed by itself. This may result in failure of the paging procedure. And, a paging relevant message for a corresponding procedure is unnecessarily transmitted, resulting in waste of resources.

However, the paging procedure to which the present invention has been applied is executed as follows.

As aforementioned, the MME 510 determines a transmission list including one or more base stations to which a paging message is to be transmitted among one or more base stations included in a base station list for the UE 100 (e.g., TAI list), based on access modes of the Home (e)NodeBs 300a and 300b, and based on whether the UE 100 is a member of the CSG supported by the Home (e)NodeBs 300a and 300b (S406). The transmission list may have information on the (e)Node 200 included in the TAI list. The TAI list includes an ID of one or more (e)NodeBs to which the UE 100 has already accessed or is able to access later, and an ID of one or more Home (e)Node Bs to which the UE 100 has already accessed or is able to access later.

If the Home (e)NodeB 300b operates in a closed access mode and if the UE 100 is not a member of the CSG supported by the Home (e)NodeB 300b, the Home (e)NodeB 300b is excluded from the base station list.

Then, the MME 510 transmits a paging message to the determined base station, e.g., the Home (e)NodeB 300a (S407). Here, if the (e)NodeB 200 is included in the TAI list, the paging message is also transmitted to the (e)NodeB 200.

The Home (e)NodeB 300a or the (e)NodeB 200 broadcasts the paging message in pursuit of the UE 100 (S408). In the present invention, paging messages are optimally transmitted to determined base stations, thereby preventing unnecessary waste of resources. Then, the UE 100 transmits a paging response message (NAS including a Service Request message) to the MME 510 through the Home (e)NodeB 300a or the (e)NodeB 200 (S409˜S410).

The MME 510 transmits an Initial Context Setup Request message to the Home (e)NodeB 300a or the (e)NodeB 200 through an S1-AP interface (S411). Accordingly, a wireless bearer is set between the Home (e)NodeB 300a or the (e)NodeB 200, and the UE 100 (S412). The Home (e)NodeB 300a or the (e)NodeB 200 transmits an Initial Context Setup Complete message to the MME 510 (S413).

Then, the MME 510 transmits a request message for request an update of the bearer, e.g., an Update Bearer Request message to the S-GW 520 (S414). And, the S-GW 520 updates the bearer established between itself and the P-GW 530 (S415), and transmits a response message, e.g., an Update Bearer Response message to the MME 510 (S416).

The S-GW 520 transmits downlink data to the UE 100 (S417).

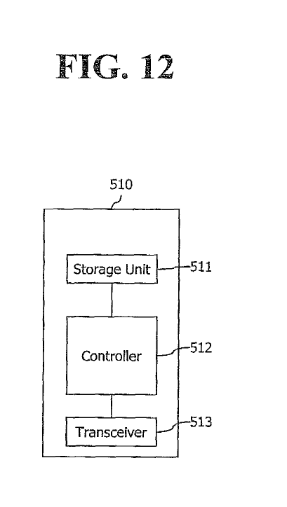

In addition, the above various embodiments may be implemented by using, computer software, hardware, or some combination thereof. For instance, the method of the present invention may be stored in the storage medium (e.g., internal memory, flash memory, hard disc, etc.), or may be implemented in codes or commands inside a software program that can be executed by a processor such as a microprocessor, a controller, a micro-controller, an application specific integrated circuit (ASIC), etc. This will be explained in more detail with reference to FIG. 12.

FIG. 12 is a block diagram of the MME 510 according to the present invention.

Referring to FIG. 12, the MME 510 includes a storage means 511, a controller 512, and a transceiver 513 (transmitting and receiving unit).

The storage means 511 stores software programs including the method shown in FIGS. 7 to 11.

The controller 512 controls the storage means and the transceiver 513, respectively. More concretely, the controller executes software programs including the method, the software programs stored in the storage means. And, the controller transmits the aforementioned signals through the transceiver.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An optimized paging method for a Home (e)NodeB system, the method comprising:
receiving, by a network entity, a notification message indicating whether downlink data for a terminal exists or not;
determining, by the network entity, one or more Home (e)NodeBs to which a paging message is to be transmitted among one or more base stations included in a base station list for the terminal, based on an access mode of the Home (e)NodeB, and based on whether the terminal is a member of a Closed Subscriber Group (CSG) supported by the Home (e)NodeB;
transmitting, by the network entity, a paging message to the determined one or more Home (e)NodeBs or one or more (e)NodeBs included in the base station list; and
receiving, by the network entity, a paging response message from a specific (e)NodeB or Home (e)NodeB among the one or more (e)NodeBs or Home (e)NodeBs to which the paging message has been transmitted.

2. The method of claim 1, wherein the base station list is a Tracking Area Identity (TAI) list.

3. The method of claim 2, wherein the TAI list comprises:
an ID(s) of one or more (e)NodeBs for the terminal; and
an ID(s) of one or more Home (e)NodeBs for the terminal.

4. The method of claim 1, wherein in the determining step, at least one of a Closed Subscriber Group (CSG) ID, a network operator policy, and an operator policy of the Home (e)NodeB is further considered.

5. The method of claim 1, after receiving the paging response message, further comprising:
transmitting an Initial Context Setup Request message to the specific (e)NodeB or Home (e)NodeB such that a radio bearer is set between the specific (e)NodeB or Home (e)NodeB and the terminal.

6. The method of claim 1, further comprising:
transmitting an Update Bearer Request message to a Serving-Gateway (S-GW) once the paging response message has been received; and
receiving an Update Bearer Response message from the S-GW.

7. The method of claim 6, wherein the data is transmitted to the terminal through the specific (e)NodeB or Home (e)NodeB after the Update Bearer Response message has been received.

8. The method of claim 1, wherein the network entity is a Mobility Management Entity (MME), or other network entity which performs a paging function.

9. A network server configured to perform a paging function for a Home (e)NodeB system, the server comprising:
a transceiver configured to receive a notification message indicating whether downlink data for a terminal exists or not; and
a controller configured to determine one or more Home (e)NodeBs to which a paging message is to be transmitted among one or more base stations included in a base station list for the terminal, based on an access mode of the Home (e)NodeB, and based on whether the terminal is a member of a Closed Subscriber Group (CSG) supported by the Home (e)NodeB,
wherein the controller controls the transceiver to transmit the paging message the determined one or more Home (e)NodeBs or one or more (e)NodeBs included in the base station list, and
wherein the transceiver receives a paging response message from a specific (e)NodeB or Home (e)NodeB among the one or more (e)NodeBs or Home (e)NodeBs to which the paging message has been transmitted.

10. The network server of claim 9, wherein the base station list is a Tracking Area Identity (TAI) list.

11. The network server of claim 10, wherein the TAI list comprises:
an ID(s) of one or more (e)NodeBs for the terminal; and
an ID(s) of one or more Home (e)Node B for the terminal.
